(19) United States
(12) Patent Application Publication
(10) Pub. No.: US 2007/0246857 A1
(43) Pub. Date: Oct. 25, 2007

(54) METHODS FOR INTERNALLY CURING CEMENT-BASED MATERIALS AND PRODUCTS MADE THEREFROM

(75) Inventors: Kimberly Kurtis, Atlanta, GA (US); Hiroki Nanko, Norcross, GA (US); Benjamin Mohr, Cookeville, TN (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 11/738,906

(22) Filed: Apr. 23, 2007

Related U.S. Application Data
(60) Provisional application No. 60/793,766, filed on Apr. 21, 2006.

(51) Int. Cl. B29C 71/00; C04B 16/00; B28B 3/00

(52) U.S. Cl. 264/236; 106/805; 264/333

(57) ABSTRACT

Methods for internally curing cement-based materials using wood-derived materials as internal curing agents are disclosed herein. The methods generally include casting a mixture of a cement-based material, mixing water, and an internal curing agent, which includes a wood-derived material, and curing the mixture. The mixture is cured using the mixing water and any water associated with the internal curing agent. The cured mixture will shrink less than if the mixture did not include the wood-derived material. Internally cured cement-based mixtures are also described.

### CROSS-REFERENCE TO RELATED APPLICATION

The present application claims the benefit of U.S. Provisional Patent Application Ser. No. 60/793,766, filed 21 Apr. 2006, and entitled “Wood-Derived Materials for Internal Curing of Cement-Based Materials,” which is hereby incorporated by reference in its entirety as if fully set forth below.

### STATEMENT OF FEDERALLY SPONSORED RESEARCH

The United States Government might have certain rights in this invention pursuant to Grant No. CMS-0122068 awarded by the National Science Foundation.

### TECHNICAL FIELD

The various embodiments of the present invention relate generally to methods of internal curing of cement-based materials. More particularly, the various embodiments of the present invention relate to methods of internal curing of cement-based materials using wood-derived materials and to the internally cured cement-based materials formed therefrom.

### BACKGROUND OF THE INVENTION

With an annual production of approximately twelve billion tons, concrete has emerged as the material of choice for modern infrastructure construction, particularly with the advent of so-called high-performance concrete. In conventional concrete, a water-to-cementitious materials ratio (w/cm) in the range of 0.40 to 0.60 is used, but the use of superplasticizers and other additives have made it possible to manufacture relatively flowable and cohesive concrete at ratios of about 0.20 to about 0.30. At these levels, it is possible to achieve strengths of about 200 to about 400 megaPascals (MPa). In contrast, conventional concrete typically exhibits strengths in the range of 30 to 50 MPa. With the decreased proportion of water in the cement/concrete mixture and with the relative impermeability at these low w/cm, the moisture level available for hydration of the cementitious phases and reaction of the pozzolanic phases becomes increasingly more important to ensure adequate strength development, to resist cracking, and to ensure the desired long-term durability is met. In particular, low w/cm cement based materials suffer from increased autogenous (or self-dessication) shrinkage, which coupled with reduced bleeding rates, can lead to early age cracking. In addition, the relatively high impermeability of such cement-based materials limits the effectiveness of external moist curing, typically applied to ordinary cement-based materials. As a result, hydration reactions may be hindered and strength development may be limited. Internal curing seeks to mitigate these issues by providing entrained or reserved water well-dispersed, within the cement-based material to promote hydration and to offset self-dessication.

Generally, concrete is plastic and workable for the first few hours after mixing and casting. Curing of the concrete (i.e., when it stiffens and becomes rigid), which proceeds via a hydration reaction, normally occurs between about 2 and about 8 hours after adding water and mixing. Portland cement hydration products generally occupy a smaller volume than the reactants, resulting in a net chemical shrinkage. In the plastic state, the material is able to contract to accommodate this strain. However, after setting, the chemical shrinkage induces an increase in internal capillary porosity, that is, those voids which are less than or equal to about 50 nanometers (nm); and when the internal relative humidity of the concrete is low, shrinkage results. Concomitant changes in surface tension, disjoining pressure, and capillary tension in the water/air menisci created in these capillary pores have each been proposed as mechanisms leading to this autogenous or self-desiccation shrinkage. If the cast concrete member is subject to internal (i.e., by aggregate or reinforcing steel) or external restraint, cracking can result from tensile stresses induced during shrinkage. High-performance concrete is particularly susceptible to self-desiccation and autogenous shrinkage early in the curing cycle owing to its already low water content, high cement content, high concentration of small solid particles, and inherently fine pore structure.

As a result, internally curing the concrete has been proposed as a method of mitigating autogenous shrinkage and related cracking. “Internal curing” refers to the use of moisture-rich materials in the fresh cement mixture to provide an additional, internal reservoir of water (i.e., not part of the mixing water considered in the water to cement ratio) to compensate for the water lost by self-desiccation. One approach includes the use of saturated, highly-porous minerals or aggregate (e.g., pumice, perlite, expanded clay aggregate, expanded shale aggregate, and expanded slate aggregate) in the fresh cement or concrete mixture. These materials, over time, release water to the hydrating paste, mitigating the effects of autogenous shrinkage and promoting cement hydration. However, control of moisture content with these materials is difficult, leading to problems in maintaining consistency. Also, owing to their large porosity and relatively large size, their use substantially reduces the strength and elastic modulus of concrete. Owing to their ability to adsorb water, clays have been proposed for this purpose, but their tendency for agglomeration in high ionic media precludes their use.

Alternative materials, which may also act as moisture reservoirs, but which are expected to less negatively impact the strength and durability of the concrete have been studied. These include super-absorbent polymers (SAPs) and diatomaceous earth. Unfortunately, these alternative materials are not ideal because their use is not cost-effective in large scale applications. In addition, because of their dimensionally instability, SAPs can also adversely affect the strength and elastic modulus of concrete.

Accordingly, there continues to be a need for alternative materials that can be used to internally cure cement-based materials. These materials should be economically viable alternatives to SAPs and avoid the strength and stiffness reduction associated with SAPs and lightweight aggregate, while minimizing the effects of autogenous shrinkage and self-desiccation exhibited in existing cement-based materials. It is to the provision of such materials and methods that the various embodiments of the present invention are directed.

### BRIEF SUMMARY OF THE INVENTION

Briefly described, the present invention provides methods for internally curing cement-based materials and the products made therefrom. For example, various embodiments of the present invention are directed to methods for internally curing cement-based materials using wood-derived materials as internal curing agents. Briefly described, the method generally includes casting a mixture of a cement-based material, mixing water, and the internal curing agent, and then curing the mixture. The mixture is cured using the mixing water and any water associated with the internal curing agent.

The wood-derived material can be present in the form of fibers, powder, pulped fibers, or a combination comprising at least one of the foregoing, such as fibers that have been agglomerated with another material, powders that have been adhered or absorbed onto the surface of another material, or the like. When fibers are used, the fibers can have an average length of about 0.01 millimeters to about 10 millimeters, and/or an average diameter of less than about 100 micrometers. However, when a powder is used, the powder can have an average longest dimension of about 100 nanometers to about 10 millimeters. The wood-derived material can be a surface-treated wood-derived material or surface-modified wood-derived material.

In preparing the mixture, the ratio of the mixing water to the cement-based material can be about 0.20 to about 0.60. Furthermore, the wood-derived material can take up about 0.001 percent to about 12 percent by weight of the mixture, based on the total weight of the mixture.

The cured mixture will shrink less than if the mixture did not include the wood-derived material. After 10 days the cured mixture experiences at least about 10 percent less strain than if the mixture did not comprise the internal curing agent. Specifically, after about 10 days the cured mixture can experience at least about 100 microstrain less shrinkage than if the mixture did not comprise the internal curing agent. After about 100 days the cured mixture can experience at least about 300 microstrain less shrinkage than if the mixture did not comprise the internal curing agent.

Other embodiments of the present invention are directed to an internally cured cement-based material. The cured cement-based material generally includes the internal curing agent comprising a wood-derived material. The wood-derived material can be in the form of fibers, powder, pulped fibers, or a combination comprising at least one of the foregoing. In addition, the wood-derived material can be a surface-treated wood-derived material or surface-modified wood-derived material.

The cured cement-based material exhibits less shrinkage than if the cured cement-based material did not comprise the internal curing agent. For example, after 10 days the cured cement-based material experiences at least about 10 percent less strain than if the cured cement-based material did not comprise the internal curing agent. More specifically, the cured cement-based material can experience at least about 100 and at least about 300 microstrain less shrinkage than if the cured cement-based material did not comprise the internal curing agent after 10 and 100 days, respectively. In some embodiments, the cured cement-based material experiences less than or equal to about 800 microstrain after 100 days.

In addition, the cured cement-based material can exhibit less cracking from shrinkage, increased mechanical strength, stiffness, fluid impermeability, and/or durability (including improved resistance to freeze-thaw action, alkali-silica reaction, sulfate attack, delayed ettringite formation, and similar forms of degradation) than if the cured cement-based material did not comprise the internal curing agent.

Other aspects and features of embodiments of the present invention will become apparent to those of ordinary skill in the art, upon reviewing the following detailed description in conjunction with the accompanying figures.

### BRIEF DESCRIPTION OF THE DRAWINGS

FIG. 1 is an environmental scanning electron microscopy (ESEM) image of kraft pulp fibers in a cement-based matrix.

FIG. 2 is an ESEM image of TMP fibers in a cement-based matrix.

FIG. 3 illustrates isothermal calorimetry results (power evolved) for composites containing various wood-derived internal curing materials in cement paste.

FIG. 4 illustrates isothermal calorimetry results (cumulative heat evolved) for composites containing wood-derived internal curing materials in cement paste.

FIG. 5 illustrates the autogenous shrinkage rates for pastes containing various amounts of kraft fibers and two different types of cellulose powder.

FIG. 6 illustrates the autogenous shrinkage rates for pastes containing various amounts of TMP fibers.

FIG. 7 illustrates the autogenous shrinkage rates for pastes containing various amounts of wood powder.

FIG. 8 illustrates the autogenous shrinkage rates for pastes containing various amounts of a superabsorbent polymer.

FIG. 9 illustrates the autogenous shrinkage rates for pastes containing TMP fibers having different wall thicknesses.

FIG. 10 illustrates the autogenous shrinkage rates for pastes containing chemically treated and untreated TMP fibers.

### DETAILED DESCRIPTION OF THE INVENTION

Referring now to the figures, wherein like reference numerals represent like parts throughout the several views, exemplary embodiments of the present invention will be described in detail. Throughout this description, various components can be identified as having specific values or parameters, however, these items are provided as exemplary embodiments. Indeed, the exemplary embodiments do not limit the various aspects and concepts of the present invention as many comparable parameters, sizes, ranges, and/or values can be implemented. The terms “first,” “second,” and the like, “primary,” “secondary,” and the like, do not denote any order, quantity, or importance, but rather are used to distinguish one element from another. Further, the terms “a”, “an”, and “the” do not denote a limitation of quantity, but rather denote the presence of “at least one” of the referenced item.

The various embodiments of the present invention provide improved methods for internally curing cement-based materials, and the resulting internally-cured cement-based materials. As used herein, the term “internal curing” refers to the use of moisture-rich materials in the fresh cement mixture to provide an internal reservoir of water, which is in addition to the initial mixing water, to compensate for self-desiccation of the cement-based material. In contrast to the prior art, the methods described herein incorporate the use of wood-based or wood-derived compositions, which can be in the form of fibers, powders, pulped fibers, or the like. The wood-derived compositions are able to contain both free and bound water. The free water (i.e., primarily water held in large pores and/or in the lumen of the wood-derived composition) and weakly bound water (i.e., water present in the cell wall) can be released into the surrounding, self-desiccating cement-based matrix over time, providing relief from self-desiccation and subsequent autogenous shrinkage.

Specific examples of cement-based materials that can be used include aluminous cement, blast furnace cement, calcium aluminate cement, Type I Portland cement, Type IA Portland cement, Type II Portland cement, Type IIA Portland cement, Type III Portland cement, Type IIIA, Type IV Portland cement, Type V Portland cement, hydraulic cement such as white cement, gray cement, blended hydraulic cement, Type IS-Portland blast-furnace slag cement, Type IP and Type P-Portland-pozzolan cement, Type S-slag cement, Type I (PMY pozzolan modified Portland cement, and Type I (SM)-slag modified Portland cement, Type GU-blended hydraulic cement, Type HE-high-early-strength cement, Type MS-moderate sulfate resistant cement, Type HS-high sulfate resistant cement, Type MH-moderate heat of hydration cement, Type LH-low heat of hydration cement, Type K expansive cement, Type O expansive cement, Type M expansive cement, Type S expansive cement, regulated set cement, very high early strength cement, high iron cement, and oil-well cement, further concrete fiber cement deposits and any composite material including any of the above listed cement.

The different types of cement can be characterized by The American Society for Testing and Materials (ASTM) Specification C-150. For example, Type I Portland cement is a general-purpose cement suitable for all uses. It is used in general construction projects such as buildings, bridges, floors, pavements, and other precast concrete products. Type IA Portland cement is similar to Type I with the addition of air-entraining properties. Type II Portland cement generates less heat, at a slower rate, and has a moderate resistance to sulfate attack. Type IIA Portland cement is identical to Type II with the addition of air-entraining properties. Type III Portland cement is a high-performance or high-early-strength cement and causes concrete to set and gain strength rapidly. Type III is chemically and physically similar to Type I, except that its particles have been ground finer. Type IIIA is an air-entraining, high-early-strength cement. Type IV Portland cement has a low heat of hydration and develops strength at a slower rate than other cement types, making it preferable for use in dams and other massive concrete structures where there is little chance for heat to escape. Type V Portland cement is used only in concrete structures that will be exposed to severe sulfate action, principally where concrete is exposed to soil and groundwater with a high sulfate content.

The cement-based material can include other components or fillers as known by those skilled in the art to which this disclosure pertains, such as those used to form various types of concretes. For example, the cement-based material can include aggregates, air-entraining agents, retarding agents, accelerating agents such as catalysts, plasticizers, corrosion inhibitors, alkali-silica reactivity reduction agents, bonding agents, colorants, and the like. “Aggregates” as used herein, unless otherwise stated, refer to granular materials such as sand, gravel, or crushed stone. Aggregates can be divided into fine aggregates and coarse aggregates. An example of fine aggregates includes natural sand or crushed stone with most particles passing through a ⅜-inch (9.5-mm) sieve. An example of coarse aggregates includes particles greater than about 0.19 inch (4.75 mm), but generally range between about ⅜-inch and about 1.5 inches (9.5 mm to 37.5 mm) in diameter, such as gravel. Aggregates such as natural gravel and sand can be dug or dredged from a pit, river, lake, or seabed. Crushed aggregate can be produced by crushing quarry rock, boulders, cobbles, or large-size gravel. Other examples of aggregate materials include recycled concrete, crushed slag, crushed iron ore, or expanded (i.e., heat-treated) clay, shale, or slate.

The wood-derived compositions include a broad class of materials generally based on one or both of cellulose and hemicellulose, which, for convenience, are collectively called “cellulosic materials” or “cellulosic compositions” hereinbelow. The hydrophilic surfaces of cellulosic materials can facilitate their dispersion and bonding to the cement-based material paste. The wood-derived composition can also include lignin, which, in binding the fibers together, can provide mechanical strength to the wood-derived composition. Cellulosic compositions are generally derived from plant fibers. Examples of cellulosic materials include woody fibers such as hardwood fiber (e.g., from broad leaf trees such as oak, aspen, birch, beech, and the like) and softwood fiber (e.g., from coniferous trees such as slash pine, jack pine, white spruce, logepole pine, redwood, douglas fir, and the like), as well as non-woody fibers, such as hemp flax, bagasse, mailla, cotton, ramie, jute abaca, banana, kenaf, sisal hemp, wheat, rice, bamboo, and pineapple. The wood-derived composition can be formed from recycled paper products, such as, for example old corrugated containers, old magazine grade paper, old newsprint, mixed office waste, tissue, or napkin.

The wood-derived compositions can be ground to powder form or pulped. For example, a kraft pulp can be formed by placing wood in a pressurized vessel in the presence of hot caustic soda and optionally sodium sulfide. This process attacks and eventually dissolves the lignin that holds the fibers to each other in the wood. Other pulping processes that can be used include stone grinding, refining, thermomechanical pulping, chemi-thermomechanical pulping, and the like. Other processes can be used to remove the lignin fraction, retaining much of the hemicellulose (which can be lost during kraft pulping and bleaching), producing holocellulose, which is generally a polysaccharide complex containing both cellulose and hemicellulose.

The wood-derived material can undergo a surface treatment or modification to alter the surface characteristics of the material itself. For example, a sizing agent can be added to the surface of the wood-derived material, as used in the paper making industry. Furthermore, wood-derived materials could be impregnated or saturated (with or without a surface coating to control the release rate) with agents whose release, through the mechanisms described above, could affect the early or late stage properties of cement-based materials. An example application includes pre-impregnation of fibers with a polymeric or mineral-based substance which would be released over time to densify the surrounding cement-based materials, increase strength and/or reduce permeability. Pre-impregnation of the wood-derived materials with polymeric or mineral materials to impart “self-healing” or “crack filling” can also be accomplished. Another example application is the pre-impregnation of the wood-derived material with a lithium-containing compound which could be released over time to mitigate expansion in cement-based materials containing alkali-reactive aggregate.

The wood-derived compositions can be implemented in combination with other materials such as any of the cement-based material fillers described above. By way of example, wood-derived powders can be disposed on the surface of normal or light-weight aggregate particles. Alternatively, the wood-derived compositions can be mixed with clay to form a larger agglomerated particle.

According to one embodiment, the fibers of the wood-derived composition can be from about 0.01 mm to about 10 mm in average length. Further, the average fiber can be about 0.5 mm to about 5 mm in length. Preferably, the average fiber can be from 1 mm to about 4 mm in length. The fibers desirably have an average diameter of less than 100 micrometers (μm), with less than 50 μm being preferred. According to one embodiment, powders of the wood-derived composition can have an average longest dimension of about 100 nm to about 10 mm. Further, the average longest dimension of the powder can be about 10 μm to about 5 mm in length. Preferably, the average longest dimension of the powder is about 0.5 mm to about 1 mm.

The mixing of the cement-based material and wood-derived materials can be carried out in many orders or manners. For example, the wood-derived material can be dry blended with the cement-based material and then combined with the mixing water. Another example of the mixing procedure involves introducing the wood-derived material to the mixing water followed by mixing and addition of the cement-based material. Yet another example involves mixing the cement-based material with the mixing water and then combining the wood-derived material with the mixture. A further example of the mixing procedure involves adding the wood-derived material and the cement-based material to the mixing water simultaneously. The combination of cement-based material, and wood-based material, and mixing water can be mixed manually or mechanically, or using a specialized processes such as the Hatschek process, slurry-dewatering, or by extrusion. In addition, chemical agents, such as water-reducing or superplasticizing chemical admixtures, can be used to improve the fluidity of the mixture and to enhance dispersion of the wood-derived material.

Generally, the wood-derived material can range from about 0.001 weight percent (wt %) to about 12 wt %, based on the total weight of the overall cement-based mixture including the mixing water (hereinafter referred to as the “composite”). More preferably, the wood-derived material will range from about 0.1 wt % to about 5 wt % of the composite. It is to be understood that the amount of the wood-derived material will be higher in a cement paste or mortar than in concrete because concrete can, for example, have about as much as 75 wt % or more of aggregate with the balance being a cement paste.

Once the composite has been sufficiently mixed, cast, compacted, and finished, it can be cured. The cement-based material can be cured using many methods. The curing method should be chosen to provide the desired properties of the hardened cement-based material, such as, durability, strength, water tightness, fire resistance, abrasion resistance, volume stability, and resistance to freezing, thawing, and deicer salts. The method chosen for curing should also provide surface strength development in the cement-based material. An exemplary temperature range for ambient or fog room curing includes about 40 degrees Fahrenheit (° F.) to about 75° F. If desired, other curing methods, such as steam curing or autoclaving, can be used. Steam curing can be performed at atmospheric pressures, where temperatures can be about 40° F. to about 200° F. at various periods in the process. During autoclaving, the curing cycle can proceed under pressure and at elevated temperatures, which can be readily determined by those skilled in the art.

During the curing cycle the composite uses not only the mixing water but also the free and weakly bound water of the wood-derived material to further the hydration reaction. In contrast to conventional systems, the additional water provided by the wood-derived material compensates for water bound within newly forming hydration products and the evolving capillary pore and interlayer structure, thus minimizing or eliminating the occurrence of autogenous shrinkage in the overall system.

The cement-based material cured with the wood-derived composition will undergo less shrinkage than the identical cement-base material cured without the wood-derived composition. In an exemplary embodiment, with proper selection of the wood-derived material, based on the wood-derived materials surface chemistry and morphology, and use at an appropriate rate, the internally cured cement-based composition can offset (i.e. 100% reduction) the shrinkage, as compared to the identical cement-base material cured without the wood-derived composition. In some cases, the use of wood-derived materials can result in expansion at early ages (i.e., less than or equal to about 1 day to less than or equal to about 7 days after mixing), which can offset shrinkage due to drying or other means, in addition to compensating for autogeneous shrinkage.

In one embodiment, the internally cured cement-based material will undergo about 10% to about 100% less strain than the identical cement-base material cured without the wood-derived composition after at least 10 days. For example, after 10 days, the internally cured composition can experience at least about 100 microstrain (με), which is expressed in parts per million, less shrinkage than the non-internally cured composition (i.e., the identical cement-based material cured without the wood-derived composition). After 100 days, the internally cured composition can experience at least about 300 με less shrinkage than the non-internally cured composition. In an exemplary embodiment, after 10 days, the internally cured composition can experience about 300 με to about 800 με less shrinkage than the non-internally cured composition; and after 100 days, the internally cured composition can experience about 500 με to about 1000 με less shrinkage than the non-internally cured composition. Preferably, the cured cement-based material will experience less than or equal to about 800 με after 100 days.

Some internal curing materials (e.g., especially fibers, owing to their aspect ratios) may afford additional resistance to drying shrinkage. Without wishing to be bound by theory, this is believed to be due to a combination of the internal curing properties afforded by the wood-derived material and the changes in the physical structure and mechanical properties, also afforded by the introduction of a wood-derived fibrous material.

In addition, other properties of the cement-based material can be improved through the use of the wood-based materials. For example, the mechanical strength, stiffness, fluid impermeability, and/or durability (including improved resistance to freeze-thaw action, alkali-silica reaction, sulfate attack, delayed ettringite formation, and similar forms of degradation) can be improved by the proper choice of internal curing agent.

### EXAMPLES

The present disclosure is further exemplified by the following non-limiting examples, wherein the following wood-based materials were examined: (1) wood powder, (2) cellulose powder, (3) unbleached kraft fibers, and (4) thermo-mechanical pulp (TMP) fibers. The effectiveness of these various potential internal curing agents were assessed through isothermal calorimetry, autogenous shrinkage measurements, and compressive strength testing.

The wood powder had an average fiber length of about 0.5 mm to about 1.0 mm, and was obtained from J. Rettenmaier in Schoolcraft, Mich. The two types of cellulose powders had average fiber lengths of 10 μm (Vitacel) and about 700 μm (Arbocel) and were also obtained from J. Rettenmaier in Schoolcraft, Mich. The fiber length of the unbleached kraft fibers was about 4 mm to about 5 mm, and the average thermomechanical (TMP) fiber length was about 1 mm to about 2 mm. The unbleached kraft pulp of Slash pine was obtained from Buckeye Technologies in Plant City, Fla. The TMP of Loblolly pine was obtained from Augusta Newsprint Company in Augusta, Ga.

For comparative examples, LiquiBlock 80HS super absorbent polymers (sodium salt of cross-linked polyacrylic acid), having a particle size distribution from about 1 μm to about 100 μm, were obtained from Emerging Technologies, Inc. in Greensboro, N.C.

### Example 1

### Preparation of High-Performance Cement Pastes

High performance cement pastes were prepared with a water-to-cementitious materials (w/cm) ratio of 0.30 using ASTM Type I portland cement, 10 wt % metakaolin (based on the weight of the cement), and deionized water (having a resistivity of about 18.2 MΩ·m). Metakaolin was chosen as it was previously found to induce more autogenous shrinkage than silica fume.

The internal curing materials were added at differing fiber mass fractions in order to entrain approximately equivalent amounts of water. At a basic (no supplementary cementitious materials) water-to-cement ratio of about 0.30, additional entrained water approximately equal to 0.050 (w/cmₑ=0.050) should mitigate autogenous shrinkage by providing enough water to prevent self-desiccation. Accordingly, this water entrainment dosage was used. However, the addition of metakaolin created a worst-case scenario for autogenous shrinkage. Thus, the actual critical water entrainment value was higher than 0.050 due to increased chemical shrinkage/self-desiccation.

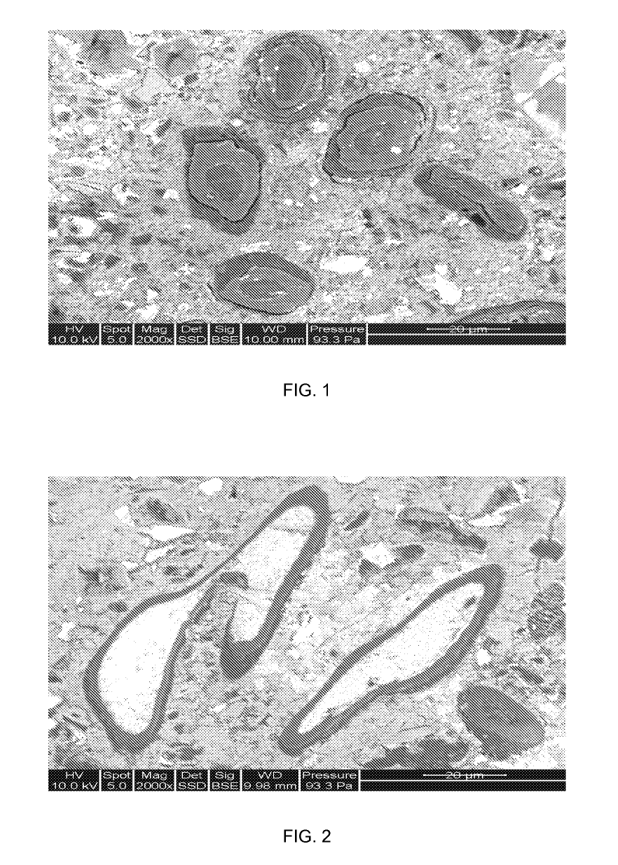

Based on image analysis during environmental scanning electron microscopy (ESEM), it was found that the average cement pore solution absorption capacity (k) of the TMP fibers and wood powder was about 3.3, while k_{average}=1.0 for the kraft fibers and cellulose powders. These differences are illustrated in FIGS. 1 and 2. For the SAPs, the absorption capacity was assumed to be about 10.0, based upon prior published research. However, though wood powder has the same average absorption capacity as TMP fibers (i.e., about 3.3), this material has been shown—by moisture isotherm curves—to release water during drying about twice as fast as TMP fibers. This occurs as the shorter wood powders have, on average, twice as many open ends per unit length as the longer TMP fibers. In other words, for the wood powders and TMP fibers, the water release rate was inversely proportional to fiber length (i.e., shorter fiber length leads to increased release rate).

Accordingly, the TMP fibers and SAPs were added at dosages such that w/cmₑ was about 0.025, about 0.050, about 0.075, and about 0.100. These entrained water dosage rates corresponded to material mass fractions of about 0.75, about 1.5, about 2.25, about 3.0% and about 0.25, about 0.50, about 0.75, about 1.0%, respectively. The wood powder was added at dosages of about 1.5, about 3.0, and about 4.5 wt % corresponding to water entrainment values of about 0.050, about 0.10, and about 0.15. Cellulose powders and kraft pulp fibers only absorb their exact mass in water (i.e., k_{average} was about 1.0); thus, the maximum dosage rate possible was about 1.0%, corresponding to w/cmₑ of about 0.010, while retaining adequate workability.

### Example 2

### Isothermal Calorimetry

For these experiments, metakaolin-less cement paste samples were prepared with a water-to-cement ratio of 0.50 and 3 wt % fibers/powder. ASTM Type I Portland cement and deionized water (resistivity of 18.2 MΩ·m) were used. The pastes were prepared by mixing the wood-derived fibers or powder and the entirety of the water for about 1 minute with a hand mixer. Subsequently, the cement was added and mixing continued for about another 4 minutes. About 18 to about 20 grams (g) of paste were added to each polyethylene ampule. The time between the end of mixing and placement of the ampule in the calorimeter was about 2 minutes. The superplasticizer was not used as to not influence cement hydration.

Hydration data was obtained using an 8-channel Thermometric TAM Air isothermal calorimeter. Samples were maintained at about 25.0±0.1 degrees Celsius (° C.) and automatic measurements were recorded every 2 minutes for 48 hours, disregarding the first 10 minutes of data due to heat generated during ampule placement.

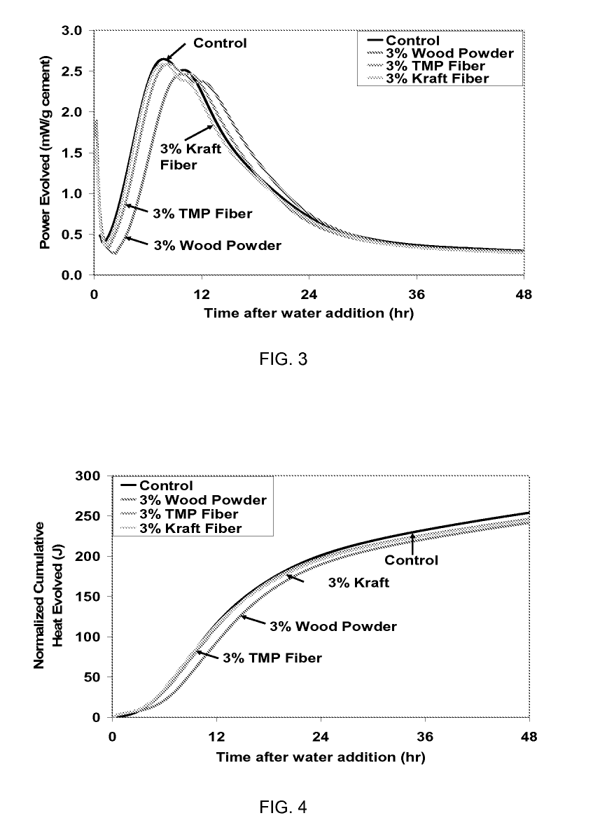

The results in FIGS. 3 and 4 indicate that differences between the control and the samples containing the fibers or powder were likely negligible in practice. TMP fibers showed little effect on the rate of hydration. However, wood powder appeared to delay setting by approximately 3 hours; it was not clear if this would translate into a noticeable effect in field or industrial production. Though, by the 48th hour, the cumulative heat evolved was similar to the other materials. In addition, overall hydration (i.e., heat evolved) for all wood-derived materials was only slightly suppressed (i.e., about 4 to about 5% lower) after 48 hr, as compared to the control. Therefore, the inclusion of any of these materials within the cement matrix did not present any notable incompatibilities.

### Example 3

### Autogenous Deformation

Pastes were prepared by mixing the internal curing materials and approximately 50% of the water for about 3 minutes at about 60 revolutions per minute (rpm) in a 1.5 liter (L) capacity Hobart mixer to ensure separation of the materials, particularly the wood-derived fibers and powders. Subsequently, the cement was added, followed by the remaining water. Mixing continued at about 120 rpm for about another 5 minutes to allow for uniform dispersion. ADVA Flow superplasticizer, obtained from WR Grace, was added at a dosage rate of about 1.5 to about 2.0 microliters per gram (μL/g) cement for all mixes. The superplasticizer dosage rate was kept fairly consistent as to minimize capillary water surface tension differences.

Autogenous deformation was measured by taking frequent linear deformation measurements of the cement paste sealed in a rigid polyethylene mold with low friction, as described by Jensen and Hansen. Autogenous deformations were measured for cement pastes containing TMP fibers, kraft pulp fibers, cellulose powder, wood powder, and the SAP. Measurements began at final set (as determined by Vicat needle penetration—ASTM C 191) and continued periodically along a logarithmic scale. The initial measurement was taken at final set to exclude plastic deformation.

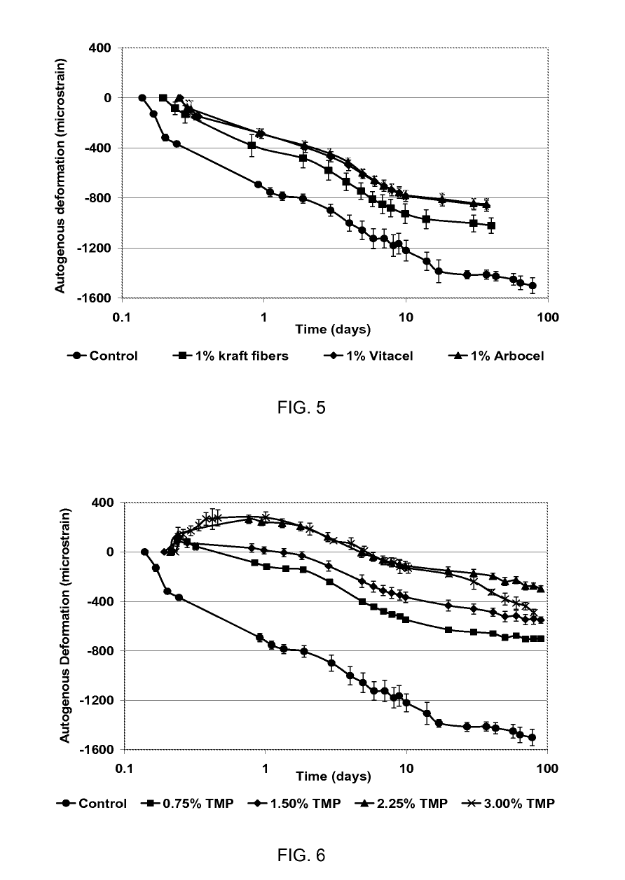

The maximum mass fraction achieved with kraft fibers and cellulose powder was limited to about 1.0%, equivalent to w/cmₑ=0.010. After 40 days, as seen in FIG. 5, the kraft fiber composites exhibited autogenous shrinkage of about −1021.8±62.1 με(με=10⁻⁶ mm/mm). The cellulose powders exhibited slightly less shrinkage of −861.8±44.1 με and −848.8±43.0 με for the two types of powders, respectively. Thus, because similar behavior was observed for the fibers and powders, it appeared that fiber length did not seem to influence autogenous shrinkage. That is, there did not appear to be any mechanical effect (i.e., internal restraint) of fiber addition, at least for the lower dosage rates and short fiber lengths (i.e., less than about 1.0 mm).

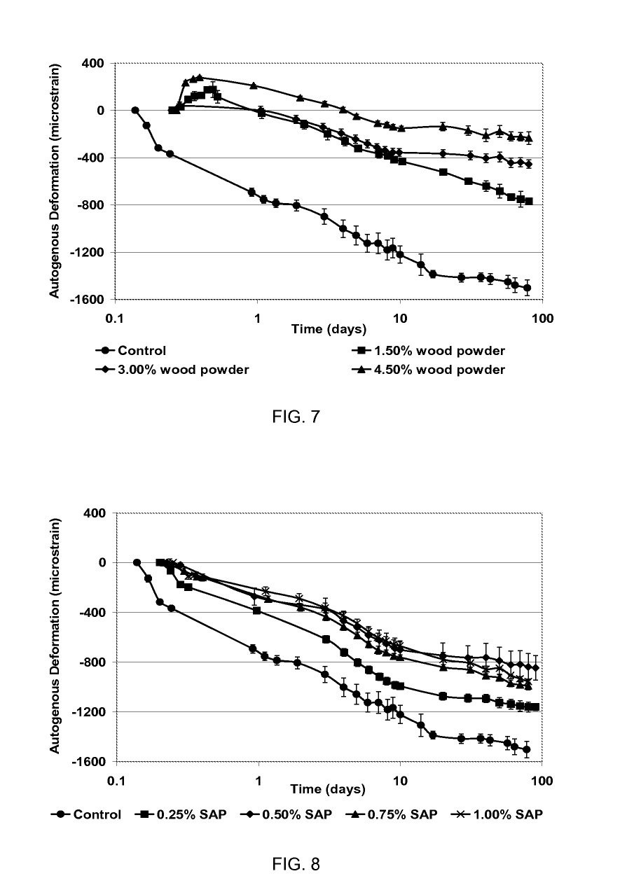

TMP fibers were found to be more easily incorporated into fresh cement, likely due to a stiffer fiber cell well (because of the presence of lignin) and shorter fiber length. Thus, good workability was easily achieved at relatively high mass fractions. Results are shown in FIGS. 6 and 7 for TMP and wood powder composites, respectively. It can be seen that as the addition rate increased, autogenous shrinkage decreased for both the TMP fiber and wood powder composites. All TMP and wood powder composites exhibited noticeable expansion during the first several days. Sample length expansion and time of observed expansion increased with increasing dosage rates, up to about 2.25% and about 4.5%, respectively, as well. After about 100 days, the minimum shrinkage observed was about −295.7±29.6 με and about −265.9±51.1 με, for the TMP fiber and wood powder pastes, respectively. This appeared to indicate that the entrained water contained within the fiber/powder lumen and cell wall was being slowly released to the self-desiccating matrix and provided the water needed for continued internal curing. It is interesting to note that the 3.0% TMP composite did not provide additional benefits as compared to the 2.25% TMP composite.

These results illustrated the effectiveness of the wood-derived materials at mitigating autogenous shrinkage. However, one of the most commonly used materials for this application has been SAPs. These polymers were tested in conjunction with the wood-derived materials in order to provide a basis for comparison. As seen in FIG. 8, the addition of SAPs to cement did provide some reduction in autogenous shrinkage. However, after about 100 days, minimum autogenous shrinkage strains were reduced to about −860.7±108.2 με, as compared to about −1511.1±88.5 με in the control at this age.

As with the TMP results, there appears to be a threshold water entrainment dosage above which the addition of water did not lead to increased benefits. For SAPs, this water entrainment threshold value was about 0.05 (0.50% SAP) and for the TMP fiber composites, it was about 0.075 (2.25% TMP). Without wishing to be bound by theory, it is believed that the differences in threshold values can be related to the water release rate of the particular material. That is, the TMP fibers are believed to release water more slowly than SAPs, thus explaining initial TMP expansion and subsequent minimal shrinkage. In addition, the threshold value can also be a function of material distribution and spacing. In this situation, the SAPs achieve maximum spacing at lower water entrainment rates than the TMP fibers.

### Example 4

### TMP Fiber Variations and Modifications

In this example, the influence of the TMP cell wall thickness and surface (i.e., internal and external) chemistry was examined. These modifications included using a thin-walled hardwood species as compared to the thick-walled TMP that was used in EXAMPLES 1-3. In addition, the thick-walled TMP fibers were treated with an alkyl ketene dimer (AKD) sizing agent in order to control the water release rate from the fibers. Cement paste matrixes were prepared and characterized as described in EXAMPLE 3.

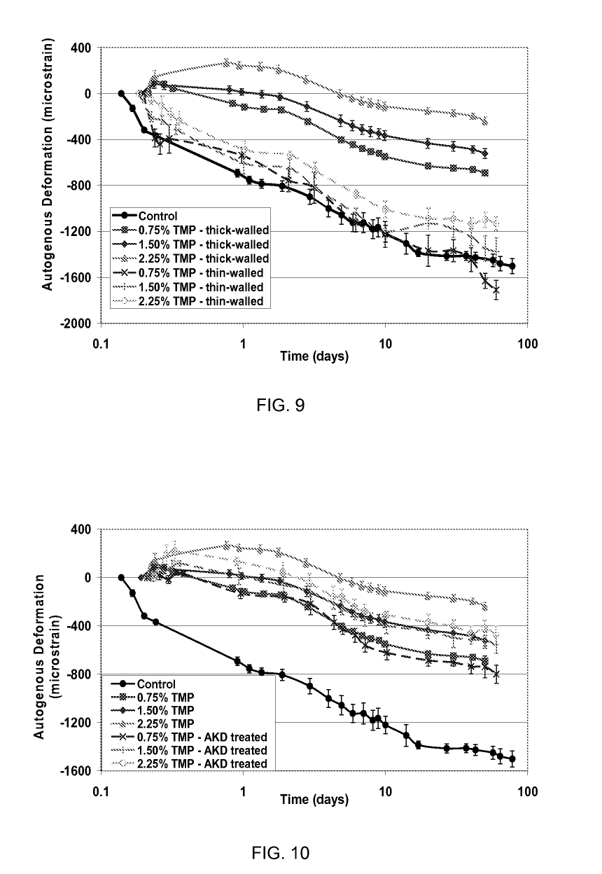

In assessing the effects of TMP fiber wall thickness, southern softwood TMP fibers with thicker cell walls were compared with northern hardwood TMP with a thinner cell wall. Data in FIG. 9 show that the use of thicker cell-walled fibers resulted in less shrinkage, and was thus more preferable than thinner cell-walled fibers. This might be because the thicker cell wall ad/absorbs more water (i.e., has a greater capacity for binding of internal curing water), and this may promote internal curing by increasing the amount of water available and by affecting the rate of moisture release (from the cell wall and within the lumen) to the surrounding paste.

With respect to the chemical modification of the TMP fiber surface, while more effective than the non-internally cured control sample, this modification did not substantially decrease the extent of shrinkage. As shown in FIG. 10, the AKD-treated fibers produced similar results as the untreated fibers, which were all significantly better than the control sample.

In these examples, several wood-derived materials were investigated as economical alternatives to superabsorbent polymers for internal curing applications. Materials were evaluated for their ability to minimize autogenous shrinkage. In general, the incorporation of wood-derived materials in cement paste slightly lowered the overall heat evolved as measured by isothermal calorimetry. TMP fibers and wood powder reduced autogenous shrinkage to a greater extent than the superabsorbent polymers, when comparing equivalent water entrainment rates (i.e., w/cmₑ).

The embodiments of the present invention are not limited to the particular formulations, process steps, and materials disclosed herein as such formulations, process steps, and materials can vary somewhat. Moreover, the terminology employed herein is used for the purpose of describing exemplary embodiments only and the terminology is not intended to be limiting since the scope of the various embodiments of the present invention will be limited only by the appended claims and equivalents thereof. For example, temperature and pressure parameters can vary depending on the particular materials used.

Therefore, while embodiments of this disclosure have been described in detail with particular reference to exemplary embodiments, those skilled in the art will understand that variations and modifications can be effected within the scope of the disclosure as defined in the appended claims. Accordingly, the scope of the various embodiments of the present invention should not be limited to the above discussed embodiments, and should only be defined by the following claims and all equivalents.

What is claimed is:

1. A method of curing a cement-based material, the method comprising:
casting a mixture comprising a cement-based material, mixing water, and an internal curing agent comprising a wood-derived material; and
curing the mixture using the mixing water and any water associated with the internal curing agent, wherein the cured mixture shrinks less than if the mixture did not comprise the internal curing agent.

2. The method of claim 1, wherein the wood-derived material comprises fibers, powder, pulped fibers, or a combination comprising at least one of the foregoing.

3. The method of claim 2, wherein the fibers of the wood-derived material have an average length of about 0.01 millimeters to about 10 millimeters.

4. The method of claim 2, wherein the fibers of the wood-derived materials have an average diameter of less than about 100 micrometers.

5. The method of claim 2, wherein the powder of the wood-derived composition has an average longest dimension of about 100 nanometers to about 10 millimeters.

6. The method of claim 1, wherein a ratio of the mixing water to the cement-based material is about 0.20 to about 0.60.

7. The method of claim 1, wherein the wood-derived material comprises about 0.001 weight percent to about 12 weight percent of the mixture, based on the total weight of the mixture.

8. The method of claim 1, wherein after 10 days the cured mixture experiences at least about 10 percent less strain than if the mixture did not comprise the internal curing agent.

9. The method of claim 1, wherein after 10 days the cured mixture experiences at least about 100 microstrain less shrinkage than if the mixture did not comprise the internal curing agent.

10. The method of claim 1, wherein after 100 days the cured mixture experiences at least about 300 microstrain less shrinkage than if the mixture did not comprise the internal curing agent.

11. The method of claim 1, wherein the wood-derived material is a surface-treated wood-derived material or surface-modified wood-derived material.

12. An internally cured cement-based material, comprising an internal curing agent comprising a wood-derived material, wherein the cured cement-based material exhibits less shrinkage than if the cured cement-based material did not comprise the internal curing agent.

13. The internally cured cement-based material of claim 12, wherein the cured cement-based material exhibits less cracking from shrinkage than if the cured cement-based material did not comprise the internal curing agent.

14. The internally cured cement-based material of claim 12, wherein the wood-derived material comprises fibers, powder, pulped fibers, or a combination comprising at least one of the foregoing.

15. The internally cured cement-based material of claim 12, wherein after 10 days the cured cement-based material experiences at least about 10 percent less strain than if the cured cement-based material did not comprise the internal curing agent.

16. The internally cured cement-based material of claim 12, wherein after 10 days the cured cement-based material experiences at least about 100 microstrain less shrinkage than if the cured cement-based material did not comprise the internal curing agent.

17. The internally cured cement-based material of claim 12, wherein after 100 days the cured cement-based material experiences at least about 300 microstrain less shrinkage than if the cured cement-based material did not comprise the internal curing agent.

18. The internally cured cement-based material of claim 12, wherein the cured cement-based material experiences less than or equal to about 800 με after 100 days.

19. The internally cured cement-based material of claim 12, wherein the wood-derived material is a surface-treated wood-derived material or surface-modified wood-derived material.

20. The internally cured cement-based material of claim 12, wherein the cured cement-based material exhibits increased mechanical strength, stiffness, fluid impermeability, and durability than if the cured cement-based material did not comprise the internal curing agent.
